(19) United States
(12) Patent Application Publication
(10) Pub. No.: US 2026/0050862 A1
(43) Pub. Date: Feb. 19, 2026

(54) AI-ASSISTED SYSTEM FOR USER TRAINING AND FLOW QUERY

(71) Applicant: WELLS FARGO BANK, N.A., San Francisco, CA (US)

(72) Inventors: Sebas Panikulam, Corcoran, MN (US); Pavan K. Dhanapuneni, Waxhaw, NC (US); Praveen Gondra, Fremont, CA (US)

(21) Appl. No.: 18/808,978

(22) Filed: Aug. 19, 2024

(51) Int. Cl. G06Q 10/0639; G06Q 10/0631; G06Q 10/0633

(52) U.S. Cl. CPC G06Q 10/06398; G06Q 10/063112; G06Q 10/063114; G06Q 10/0633

(57) ABSTRACT

Systems and methods for AI-assisted user training and flow query including receiving training including tokenizing the training data with a language learning model into one or more vectors, including a processing vector, and storing the one or more vectors. The systems and methods may receive a request from a user and generate a proficiency score by inputting the request into an adaptive response engine comprising the proficiency vector and proficiency logic and assign the proficiency score to the user. The systems and methods may generate a response associated with the request based on the proficiency score and programed query response logic and output the response.

### FIELD OF INVENTION

The present disclosure generally relates to an interface for implementing an AI-assisted tool, and more particularly to systems and methods for enabling an AI-assisted tool to train users in adjusting to new workflows, and to provide an interface for the users to query a training database.

### BACKGROUND

Current interfaces for task and project management can lead to challenges in onboarding users and new team members. With traditional interfaces, users are required to sift through vast amounts of documentation and complex codebases to comprehend new workflows effectively. To understand previously implemented complex logic, users must traditionally review multiple documents or examine various sections of application code to understand task status. Critical information is scattered across various platforms, making it difficult for team members to access what they need efficiently. Outdated and obsolete documentation can moreover lead to incorrect understandings of task status, further compounding inefficiencies in gaining familiarity with new task environments.

With prior interfaces, new or less experienced users are required to rely heavily on more senior guidance due to limitations in task management and training interfaces. Additionally, prior training interfaces lacked dependency analysis, identifying how changes to one component in a software environment would impact other components. These systems lacked a robust forecasting system, limiting the ability of users of the interface to predict efforts and sizing requirements for future project installations.

### SUMMARY

According to certain embodiments, an AI-assisted user training system receives training data from one or more data sources. The AI-assisted user training system includes a language learning model (LLM) to tokenize the training data into one or more vectors including a proficiency vector and storing the one or more vectors. The AI-assisted user training system receives a request from a user, for instance through a chat-based user interface and can generate a proficiency score by inputting the request into an adaptive response engine comprising the proficiency vector and proficiency logic. The AI-assisted user training system assigns the proficiency score to the user. The AI-assisted user training system then generates a response associated with the request based on the proficiency score and programmed query response logic; and outputs the response.

Another embodiment relates to a method that includes receiving training data and tokenizing the training data with a language learning model into one or more vectors including a proficiency vector and storing the vectors. The method includes receiving a request from a user and generating a proficiency score by inputting the request into an adaptive response engine comprising the proficiency vector and proficiency logic. The user may be assigned the proficiency score. The method further includes generating a response associated with the request based on the proficiency score and programmed query response logic and outputting the response.

A further embodiment relates to a computer-readable storage device that stores executable instructions that, in response to execution by a processor, cause the processor to perform operation including receiving training data and tokenizing the training data with a language learning model into one or more vectors including a proficiency vector and storing the vectors. The operations include receiving a request from a user and generating a proficiency score by inputting the request into an adaptive response engine comprising the proficiency vector and proficiency logic. The user may be assigned the proficiency score. The operations further include generating a response associated with the request based on the proficiency score and programmed query response logic and outputting the response.

These illustrative aspects and features are mentioned not to limit or define the presently described subject matter, but to provide examples to aid understanding of the concepts described in this application. Other aspects, advantages, and features of the presently described subject matter will become apparent after review of the entire application.

### BRIEF DESCRIPTION

A full and enabling disclosure is set forth more particularly in the remainder of the specification. The specification makes reference to the following appended figures.

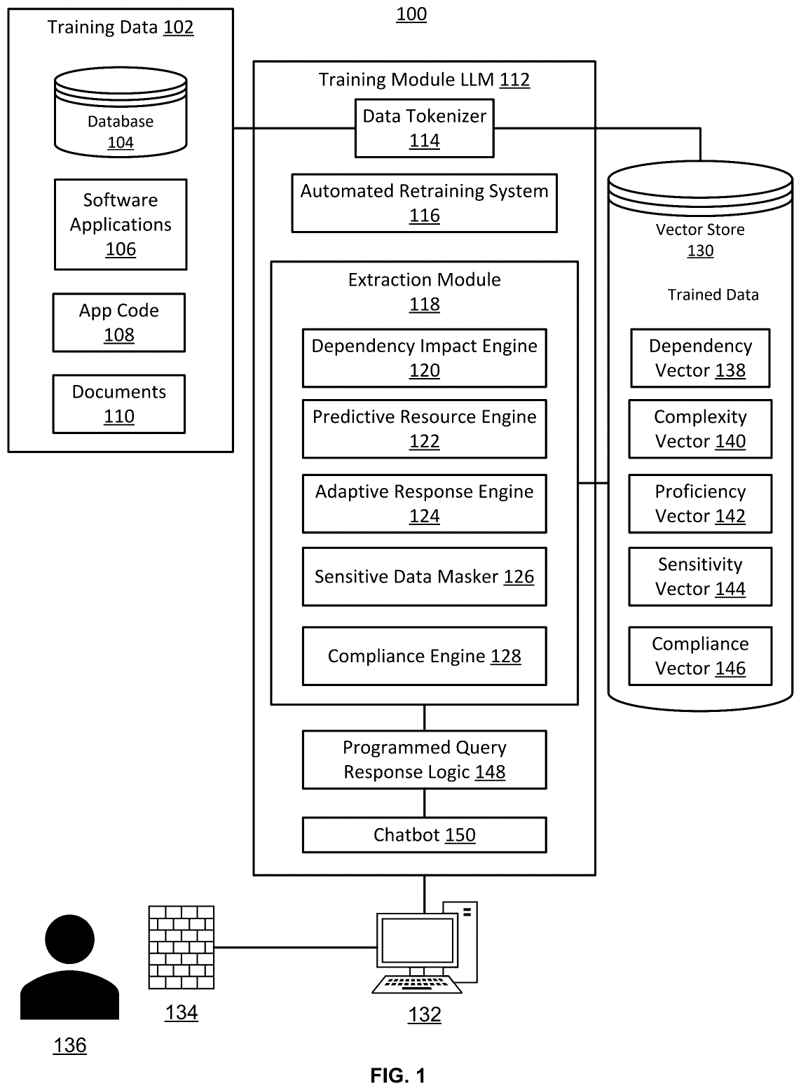

FIG. 1 illustrates a system for capable of providing a training interface according to one embodiment.

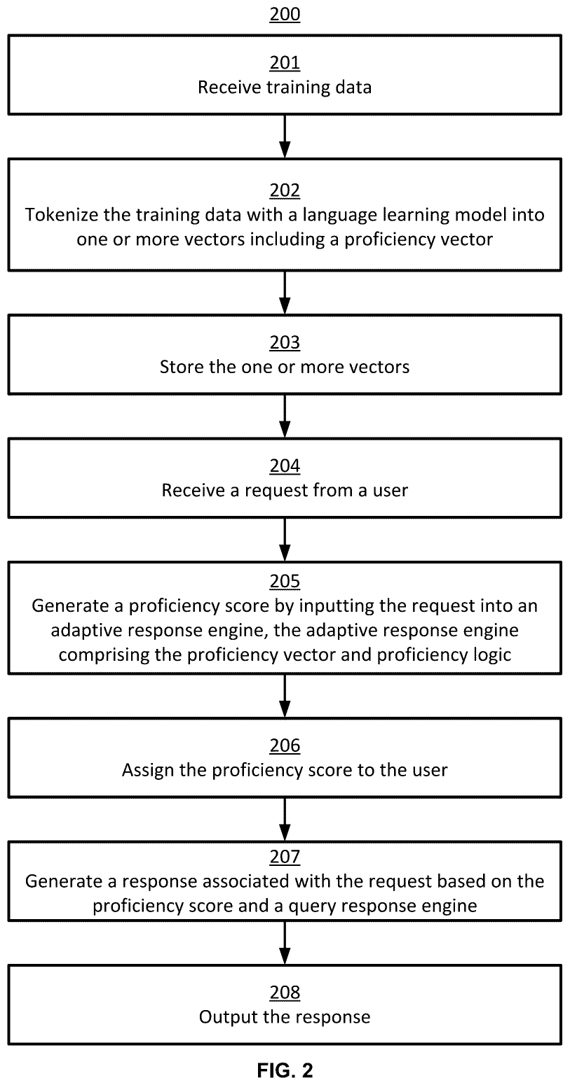

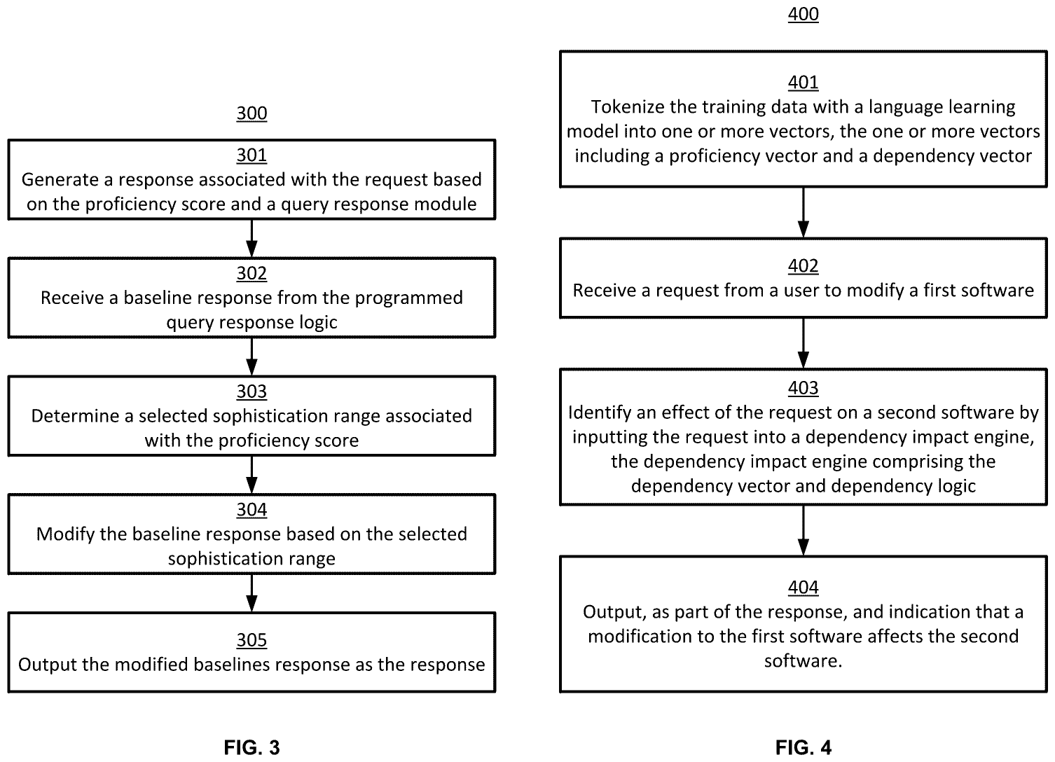

FIGS. 2-3 illustrate methods for determining an adaptive response to a user request according to one embodiment.

FIG. 4 illustrates a method of identifying effects related to modifying software according to one embodiment.

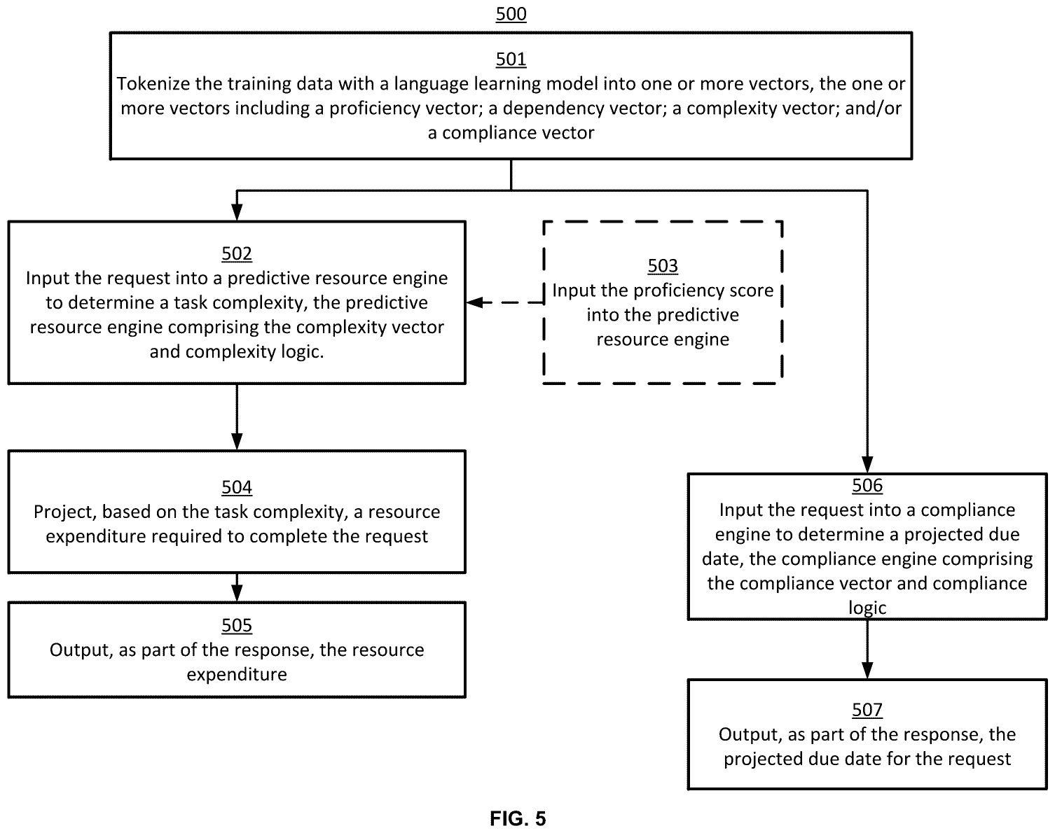

FIG. 5 illustrates a method for predicting resource expenditures and due dates in response to a user request according to one embodiment.

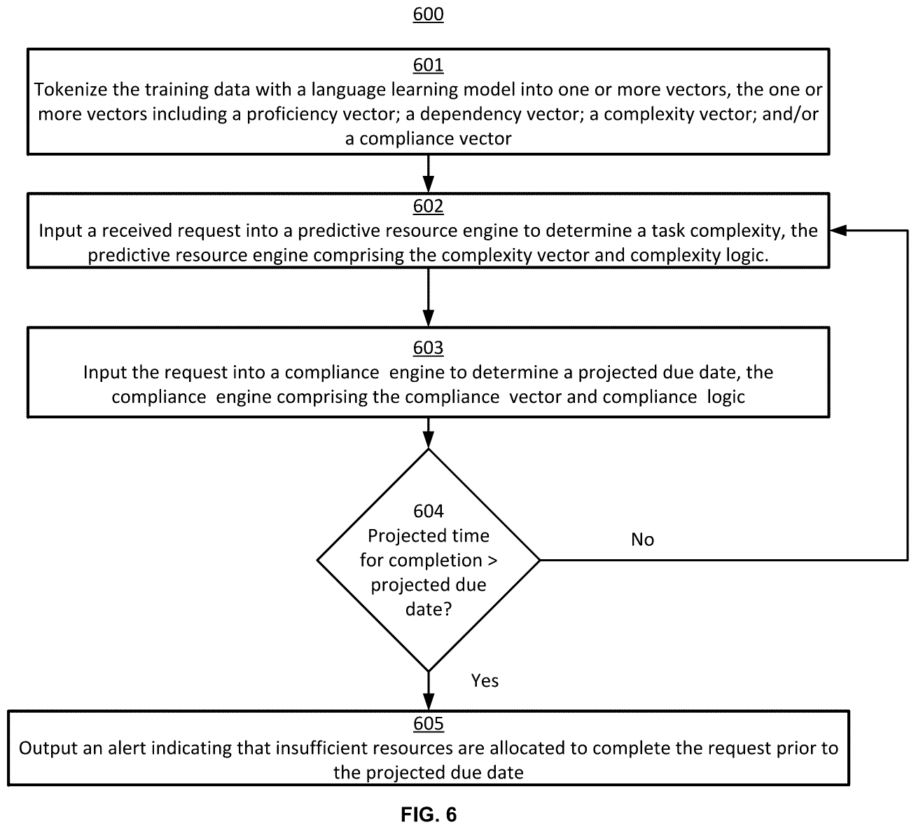

FIG. 6 illustrates a method for outputting alerts based on resource expenditures and due dates according to one embodiment.

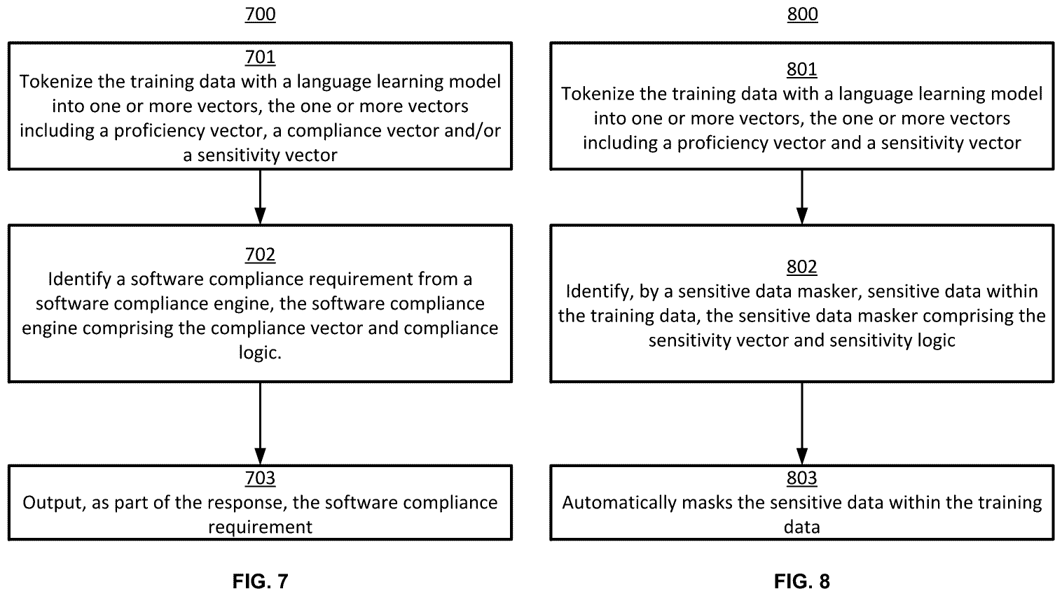

FIG. 7 illustrates a method for outputting responses based on software compliance logic according to one embodiment.

FIG. 8 illustrates a method of masking sensitive data within the training data according to one embodiment.

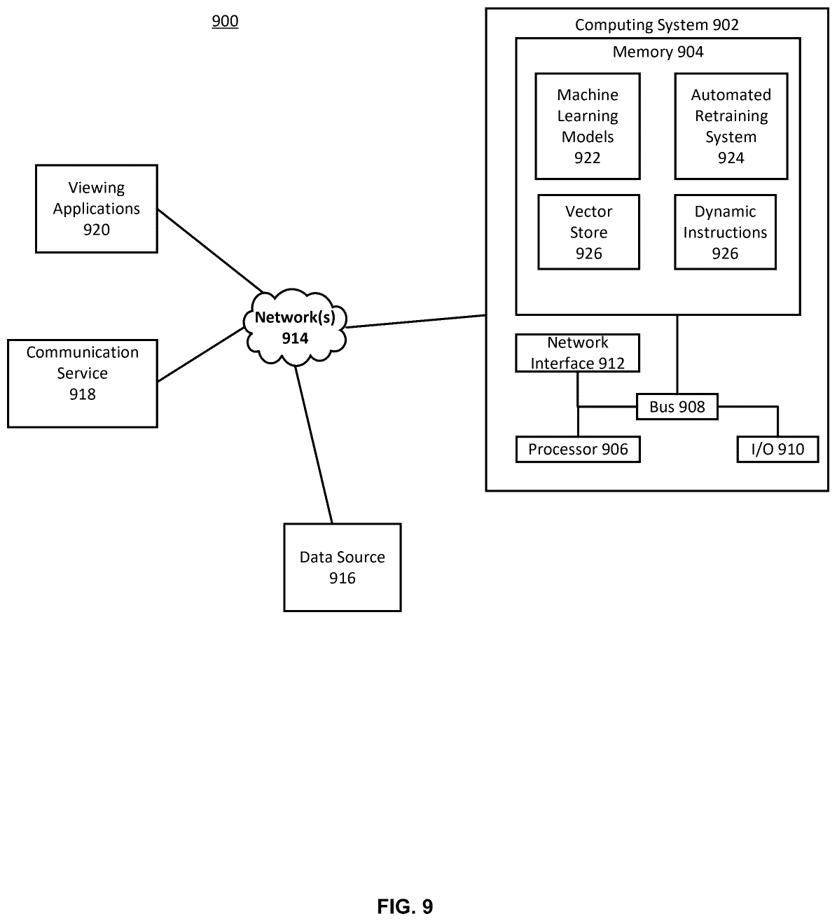

FIG. 9 illustrates a block diagram for an example computing environment capable of executing the described systems and methods according to one embodiment.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Example of a System for AI-Assisted User Training

In one illustrative embodiment, a system for AI-assisted user training includes an application for receiving training data from a collection of data sources, converting the training data into feature vector embeddings, and providing one or more extraction module components to enable the application to provide various insights and predictions to various users. The training data can include data from various sources such as database entries, application code, documents such as and PDFs, and emails, among other sources. Additionally, an Application Programming Interface (API) may allow for training data to be ingested from various workflow and task management resources including JIRA, Confluence Pages, Service Now, and other enterprise databases. An internal custom language learning model (LLM) may then be trained with application and domain specific data.

The extraction module includes one or more sub-modules or engines enabled by the LLM, the one or more engines capable of operating on machine learning trained data, e.g., vectors and embeddings, including vectors stored in a vector store database. Some components of the extraction module, such as a predictive resource engine, may be trained on training data such as software applications, application code, and project log history, to generate machine learning-based predictions of resource allocation to assist a chatbot in responding to user requests. Other components of the extraction module, such as a sensitive data masker, may include programmed logic that may operate independently of non-LLM machine learning models to perform operations within the system.

For example, one component of the extraction module, the dependency impact engine, may be trained based on the feature vector embeddings to map dependencies between software applications, modules, and services. The model can provide a clear overview of how changes in applications can impact other applications. The dependency impact engine can help developers understand dependencies, thereby reducing time and errors in manual analysis. The application ensures modifications to an application are made with clear understanding of their ripple effects, enhancing reliable implementation of new applications within a project.

The predictive resource engine, also referred to as the predictive insights core, may be trained on data from project management data sources such as JIRA and Service Now to forecast future efforts and resource expenditures in implementing new tasks. For instance, project management data can include historic completion of other tasks. Tasks determined to have a greater similarity to a requested project may be accorded greater weight in forecasting resource expenditures and timelines for completing a requested task. The predictive resource engine may couple with the dependency impact engine to more accurately predict expenditures and timelines for completing the requested task. Therefore, users querying the AI-assisted user training module regarding task completion can receive an estimate for how much effort would be required to finish a task.

The extraction module within the AI-assisted user training system can include an adaptive response engine. The adaptive response engine can be trained based on the input feature vectors and with natural language processing to analyze text entered by users, such as queries by users, and then assess their proficiency level with respect to specific tasks. Thus, each user inputting requests may be assigned a user profile assessing their proficiency with respect to a given task. The adaptive response engine may then adjust the complexity and detail of responses generated by a chatbot responding to the user. As one example, less proficient users may receive clear and unambiguous guidance, while users identified as proficient by the adaptive response engine may receive more in-depth and technical responses generated by the chatbot. The adaptive response engine may thereby enhance user experiences by delivering personalized, context aware answers tailored to individual skill levels.

The extraction module can include a sensitive data masker module. The sensitive data masker may be configured to protect privacy and ensure sensitive compliance by masking sensitive data unnecessary for training purposes. The sensitive data masker can scan the training data to identify and obfuscate personally identifiable information (PII) and other confidential data. Such identified sensitive data will then be removed from the training data set prior to input into the other modules.

The extraction module can include a compliance engine, also referred to as a regulatory data and timeline extractor. The compliance engine may be trained to efficiently extract regulatory data and enforcement timelines from the training data. Using NLP techniques such as naive Bayesian classifiers and/or term frequency inverse document frequency (TF-IDF) processing, the compliance engine can identify and retrieve relevant regulatory information including key dates and timelines for legal documents, complaint reports, and other preloaded data. The compliance engine can thereby ensure the AI-assisted user training system remains compliant with industry standards and legal requirements by continuously monitoring and updating regulatory information.

The AI-assisted user training system may include other features such as an automated retraining system. The automated retraining system may be a fully automated component configured to ensure the AI-assisted user training system remains up-to-date by periodically importing data from various sources. The automated retraining system may then retrain the LLM and individual machine learning models and update vectors with the newly imported training data.

The AI-assisted user training system may include a user-interface in the form of a chatbot. The chatbot can use natural language processing techniques to receive queries and messages from a user and respond accordingly. Operating in conjunction with the adaptive response engine, the chatbot can identify users based on their user-profile and deliver context-aware, role-specific responses, thereby ensuring that users receive relevant and accurate information tailored to their needs.

### Illustrative Use Cases for AI-Assisted User Training

The AI-Assisted User Training system provides for a variety of interfaces allowing for users, such as onboarding new team members, or more established project managers, to query the system and receive responses aiding in project management and training. The user can query the system by inputting requests. Requests can include a request for information related to modifying one software program, the requirements to develop a software program, locations of reference documents related to the software, or the like.

In one example, a user such as a new team member unfamiliar with the project workflow topology can interactively query the system for insights on the application or specific workflows. The user may query the AI-assisted user training system for the current status of a given project. The AI-assisted user training system, relying on the adaptive response engine and chatbot, can determine that the user is within a lower proficiency band, and output a response back to the user tailored to the user's skill level. The AI-assisted user training system can also rely on the dependency impact engine to indicate to the user all the applications that would be affected by changes made to a target application.

In another example, a team may be planning to implement a change to one application or software within a software environment. One of the team members, such as the project manager, can login to the system to inquire about potential effects on interconnected applications related to updating a target application. The system can generate a response indicating the downstream effects of modifying the target application, and can provide resource expenditure estimate including the effort, size estimations and sizing requirements, and time, which would be required to modify the target application. In such a way, the project manager can better plan for resource allocation and resource expenditures related to work on any target application.

In another use-case example, the system is trained to determine expected regulatory requirements, timelines, and sensitivities based on the training data ingested. The system can, based on training data including regulatory documents, output predictions of when a program must be deployed. Additionally or alternatively the system can indicate to a requesting user the compliance documents that are most relevant to the software development. The system may determine, based on its training, that some information is sensitive and not able to be presented to the requesting user based on the user's profile. In response, the system may automatically mask or redact information to prevent unauthorized users from having access to regulated or privileged information. These above examples provide non-limiting use cases of the applicability of the AI-assisted training system. Additional use cases may become apparent as discussed in relation to the following additional examples.

### Example System for AI-Assisted User Training

FIG. 1 illustrates a system for AI-assisted user training. The AI-assisted user training system 100 includes training data 102, a training module 112, a vector store 130, and an interface 132 for interacting with one or more users 136. In some examples, the training data 102, training module 112, and vector store 130, among other components of FIG. 1, may operate on different cloud service provider infrastructure.

The training module 112 can receive and/or ingest training data 102 from a variety of sources and corpora. Training data 102 can come from one or more databases 104. The databases can pertain to software applications 106, application code 108, and/or documents 110. Software applications 106 providing training data 102 may be accessed by an API configured to retrieve the training data 102 on behalf the training module 112. Software applications 106 may include project management applications such as JIRA and document archive software such as Confluence. In one example, training data 102 may include historical data related to past JIRA stories, epics or initiatives. Other training data 102 provided by software applications 106 can include enterprise architecture such as in-house developed software for management of enterprise specific tasks including applications in industries such as banking, healthcare, defense, or the like.

Training data 102 can also include application code 108, and documents 110 such as WORD or PDF files, emails, or the like. The application code 108 and documents 110 may be accessed from the one or more databases 104, or from software applications 106. Training data 102, such as the database 104 data, software applications 106, application code 108, and documents 110 may be received by a variety of means including web-scraping agents, data ingestion software such as Apache KAFKA, or the like.

The training data 102 may be received by the training module 112. The training module 112 may be a custom LLM programmed to acquire the training data 102 and tokenize 114 the training data 102 for storage within a vector store 130. The training module 112 may perform a number of preprocessing techniques including gathering the training data 102, preprocessing the training data 102, and tokenizing 114 the training data into tokens or embeddings. Embeddings may be phrase-based, word-based, sentence based, or any combination of those listed. Different embeddings may be generated for different components of the training data 102. For instance, application code may be tokenized into a code-based embedding and a syntax based embedding.

The training module 112 can employ natural language processing and textual analysis to computationally identify and extract subjective information according to a number of attributes listed in the vector store 130. The training module 112 may employ shallow language processing algorithms including probabilistic statistical models such as naive-bayes or Latent Dirichlet Allocation (LDA) to generate each data set stored in the vector store. Additionally or alternatively, deep learning models such as recursive neural networks (RNN) may be used to generate data stored in the vector store. Other examples of NLP techniques used may include, for instance, TF-IDF processing to identify the frequency and uniqueness of terms in various data sources to assist the training module 112 in retrieving documents it identifies as relevant to a user request.

The trained data stored in the vector store 130 includes the dependency vectors 138, complexity vectors 140, proficiency vectors 142, sensitivity vectors 144, and compliance vectors 146. Each type of trained data stored in the vector store 130 may be trained per similar machine learning model architectures such as RNN structures, alone or in combination with other NLP structures including LDA or naive bayes models. The models generating the data within the vector store 130 may be trained on different subsets of the training data 102. For instance, proficiency vectors 142 may be trained on corpora including documents 110, but not application code 108, while complexity vectors 140 may be trained application 106 corpus and documents 110 corpus. Thus, each set of vectors 138-146 stored in the vector store 130 may represent data from separately trained machine learning models.

The extraction module 118 can include one or more engines 120-128, each storing logic and tied to data within the vector store 130, configured to perform specific functions and tasks. The extraction module 118 can include a dependency impact engine 120 tied to the dependency vectors 138. The dependency impact engine 120 may include internal logic for operation with the dependency vectors 138 such that the dependency impact engine 120 can map dependencies between modules and services. The dependency impact engine 120 may provide an overview of how changes in applications can impact other applications. Thus, once a user submits a request asking to modify one application, the dependency impact engine 120 may provide a response providing a clear understanding of ripple effects. The dependency vectors 138 enabling the dependency impact engine 120 may be vector data generated by the training module 112 based on application code 108 and other documents 110 pulled from the training data 102.

The extraction module 118 can include a predictive resource engine 122, also referred to as a predictive insight core. The predictive resource engine 122 may include internal logic capable of providing a projected time estimate for completion of a task as input through a user request. The predictive resource engine 122 may be enabled by complexity vectors 140 generated by the training module 112. The training module 112 may ingest data from project management data sources such as JIRA and Service Now to generate the complexity vectors 140. The predictive resource engine 122 may also communicate with the dependency impact engine 120 to identify dependencies between applications to further forecast efforts to complete a task.

The extraction module 118 can include an adaptive response engine 124. The adaptive response engine 124 may include internal logic capable of analyzing a request and assessing the requesting user's proficiency level. The adaptive response engine 124 may be enabled by proficiency vectors 142 generated by the training module 112. The training module 112 may ingest training data 102 from databases 104 and documents 110 and apply NLP techniques such as predictive naive bayes classification to predict a proficiency level given a text based input. The training of the complexity vectors 140 may be supervised using labeled data sets to train the training module 112 to generate the proficiency vectors 142.

The extraction module 118 can include a sensitive data masker 126. The sensitive data masker 126 may include internal logic capable of scanning the training data 102 and response outputs for masking sensitive data such as PII and other confidential data. The sensitive data masker 126 may be called prior to the training module 112 generating the other data in the vector store 130 such as the complexity vectors 140. Instead, the sensitive data masker 126 may be executed by the training module 112 to clean the training data 102 by removing PII and other confidential and sensitive data prior to the training module 112 executing other training functions. The sensitive data masker 126 may also machine learning trained, e.g., by including sensitivity vectors 144 trained on previously identified documents and training data 102 identified as having sensitive data. Thus, the sensitive data masker 126, through the sensitivity vectors 144 trained by the training module 112, may learn to predict which documents are prone to containing sensitive data.

The extraction module 118 can include a compliance engine 128. The compliance engine 128 may include internal logic capable of analyzing a request and assessing key dates and timelines for delivery of a project. The compliance engine 128 may be enabled by compliance vectors 146 generated by the training module 112. The training module 112 may ingest training data 102 from databases 104 and documents 110, particularly regulatory databases and documents, and apply NLP techniques such as predictive naive bayes classification to predict a key dates to achieve goals identified within a request.

The training module 112 is also shown containing programmed query response logic 148 communicatively coupled to the extraction module 118 and chatbot 150. The programmed query response logic 148 may be able to process user requests received through the chatbot 150, communicate with one or more components of the extraction module 118, and provide a response output through the chatbot 150. In some examples, for instance, depending on which of the extraction module 118 components 120-128 are trained with vectors stored in the vector store 130, the programmed query response logic 148 may use the extraction module 118 component 120-128 to determine a response output through the chatbot 150. The programmed query response logic 148 can receive a user request, process the request into one or more vectors, and compare the request vectors to those in the vector store 130 per interfacing with the extraction module 118. The programmed query response logic 148 may generate baseline responses to user requests, based on one or more of extraction module 118 components 120-128, and may then further modify its response based on the adaptive response engine 124 determining a proficiency score associated with the user 136.

The training module 112 also includes a chatbot 150 for generating text output through an interface 132. The chatbot 150 may rely on NLP techniques provided within the training module 112. The chatbot 150 may be trained to receive and parse requests input from a user 136 through interface 132, provide the parsed requests to one or more of the extraction modules 118, and provide a response to the user 136 in text-based format.

The training module 112 can also include an automated retraining system 116. The automated retraining system 116 may periodically reimport the training data 102 from the various corpora and data source 104-110. In such a manner, the automated retraining system 116 can ensure that the extraction module 118 and the chatbot 150 more generally remain up to date with the latest data.

Users 136 interfacing with the training module 112 can include project managers, junior developers, more senior developers, or anyone with access the to the chatbot 150. Access to the chatbot 150 may be filtered by an authenticator 134 such as a password based system, multi-factor authentication system, or the like. The authenticator 134 may also generate and provide metadata for processing by the training module 112. For instance, when a user 136, accessing through the authenticator, sends a request through the interface 132, the authenticator may append metadata indicating the type of user, e.g., whether the user accessed the training module 112 is a project manager, to the request, for processing by the one or more extraction module 118 components 120-128.

### Example Method for Determining an Adaptive Response

FIGS. 2-3 illustrate methods 200 300 for determining an adaptive response to a user request according to one embodiment. As with all other figures, not all operations may necessarily be present in each example provided herein. Other examples may include more operations, fewer operations, different operations, or a different order of the operations shown

Turning to FIG. 2, FIG. 2 is a method 200 illustrating how the AI-assisted user training system 100 may receive requests and output responses with aid of a LLM according to aspects of the disclosure. At step 201, the AI-assisted user training system 100 receives training data 102. Training data 102 may be received by one corpus of text or a various corpora including databases 104, software applications 106, application code 108, and/or documents such as PDFs and emails. Web-scrapers and other information retrieval and ingestion tools may be used to acquire training data 102 from sources including those external to an enterprise's internal database which may otherwise store the various corpora including the databases 104, software applications 106 and the like.

At step 202, the AI-assisted user training system 100 tokenizes the training data 102 with a training module 112 including a language learning model into one or more vectors including a proficiency vector 142. Using natural language processing techniques, such as the data tokenizer 114, the training module 112 can receive training data 102 and transform the data, e.g., through tokenization, into one or more vectors as stored in the vector store 130. The training module 112 may also perform additional natural language processing techniques such as machine learning as described to the engines within the extraction module 118. In the proficiency vector 140 case, the training module 112 may include a machine learning model trained on other user's performance data and other data within the training data 102 to generate proficiency vectors 142.

At step 203, the AI-assisted user training system 100 stores the one or more vectors 138-146. The vectors may be stored in one or more vector stores 130. The vector store 130 may comprise one database or multiple databases and the vectors may be stored in separate vector store 130 databases. The vector store 130 may be stored in on location or across a multiple, e.g., as in a distributed database or computing environment.

At step 204, the AI-assisted user training system 100 receives a request from a user 136. The request can take any form of interaction with the training module 112. For instance, the training module 112 may interact with the user 136 through an interface 132. The interface 132 may be a chatbot 150 based interface 132 relying on the training module 112 to receive requests from the user 136 and output responses. For instance, the request may comprise a query where the user 136 enters the query through the interface 132. The query may relate to a time estimate to complete a task, what is required in a given task, a request to produce relevant documents for a given task, or the like.

At step 205, the AI-assisted user training system 100 generates a proficiency score by inputting the request into an adaptive response engine 124, the adaptive response engine 124 comprising the proficiency vector 142 and proficiency logic. The adaptive response engine 124 may be configured to determine the proficiency of the request through LLM techniques by detecting a relative proficiency of the user 136 inputting the request based off semantic analysis of the words input into the request. The proficiency vector 142 may be generated by a machine learning model of the training module 112 trained to aid in the semantic analysis of requests to determine user proficiency. Additionally or alternatively, the adaptive response engine 124 may determine the proficiency of a request of a user 136 based on metadata associated with the user 136, e.g., their verified credentials that are transmitted with the request. For instance, the proficiency logic may recognize that users 136 submitting a request who are identified as having a certain role, e.g. project manager, may be given an elevated proficiency score compared to new users.

At step 206, the AI-assisted user training system 100 assigns the proficiency score to the user 136. Each user 136 accessing the AI-assisted user training system 100, for instance, through the authenticator 134, may be assigned a user-profile during the authentication process. The user profile may be based on the user's authentication. For instance, users 136 who access the AI-assisted user training system 100 through administrator log-ins may be assigned a user-profile associated with administrator permissions and/or a user proficiency based on their status as an administrator.

At step 207, the AI-assisted user training system 100 generates a response associated with the request based on the proficiency score and programmed query response logic 148. In some examples, as in the case of method 300 discussed with respect to FIG. 3, the query response logic 148 can identify a baseline response to the user request, through communication with the extraction module 118, and then the adaptive response engine 124 may modify the baseline response prior to the AI-assisted user training system 100 outputting the response.

At step 208, the AI-assisted user training system 100 outputs the response. The response may be output, for instance, through a chatbot 150 based interface displayed on interface 132. Thus, the user generated request may take the form of user-entered string through the interface 132, and the output response provided by the AI-assisted user training system 100 may be provided on the same interface.

Turning to FIG. 3, FIG. 3 includes a method 300 illustrating how the AI-assisted user training system generates a response associated with a request based in part on a user's proficiency score according to one embodiment. Step 301 is shown as similar to step 205 of method 200 of FIG. 2. FIG. 3 further illustrates steps that may be performed in addition or alternatively to those discussed with respect to FIG. 2 starting with step 205.

At step 302, the AI-assisted user training system 100 receives a baseline response from the programmed query response logic 148. The programmed query response logic 148 is able to generate a baseline response by communicating with one or more of the extraction module 118 components 120-128 depending on the request received from the user 136. For instance, a request for estimation of how long a task may take may cause the programmed query response logic 148 to retrieve data from the predictive resource engine 122, while a request asking what relevant documents are necessary to develop a program may cause the programmed query response logic 148 to retrieve data from the compliance engine 128 and dependency impact engine 120.

At step 303, the AI-assisted user training system 100 determines a selected sophistication range associated with the proficiency score. The adaptive response engine 124 may include logic such as a list of sophistication ranges in generating a response. There may be multiple dimensions of sophistication ranges, e.g., a user may be identified as sophisticated with respect to one task, but less sophisticated with respect to another class of tasks. The sophistication ranges may be percentage based e.g., three sophistication ranges may be provided for a certain task response corresponding to the lower, middle, and upper third percentiles. More or fewer sophistication ranges may be provided according to the given request.

At step 304, the AI-assisted user training system 100 modifies the baseline response based on the selected sophistication range. The adaptive response engine logic may include instructions to modify responses based on the associated proficiency scores. For instance, requests associated with a proficiency score in a lower sophistication may cause the adaptive response engine 124 to modify the baseline response by changing the syntax of the response, the types of documents that may be linked in the baseline response, the level of detail or nuance in the response, or the like.

At step 305, the AI-assisted user training system 100 outputs the modified baseline response as the response. As in other examples, the response may be output through a chatbot 150 on one or more interfaces such as interface 132.

### Example Methods for Outputting Responses Predicting Resource Expenditure

FIG. 4 illustrates a method of identifying effects between software according to one embodiment. At step 401, the AI-assisted user training system 100 tokenizes the training data 102 with a language learning model into one or more vectors, the one or more vectors including a proficiency vector 142 and a dependency vector 138.

At step 402, the AI-assisted user training system 100 receives a request from a user to modify a first software. The request to modify the first software may for instance be to add, remove, or replace a package or function within the software.

At step 403, the AI-assisted user training system 100 identifies an effect of the request on a second software by inputting the request into a dependency impact engine 120, the dependency impact engine 120 comprising the dependency vector and dependency logic. In such a way, users, such as developers can learn dependencies between the first software and any second software efficiently, reducing time and errors in manual analysis. Modifications may then be made with clear understanding of ripple effects, enhancing application and reliability of the modifications.

At step 404, the AI-assisted user training system 100 outputs, as part of the response, an indication that a modification to the first software affects the second software, for instance, through the chatbot 150 and interface 132. While reference is made to a first and second software, the AI-assisted user training system may compare the effects of modifications to the first software to any number of software and output to as part of the response, an indication of the effects of the modification to the first software of additional software.

### Example Methods for Outputting Responses Predicting Resource Expenditure

FIG. 5 illustrates a method for predicting resource expenditures and due dates in response to a user request according to one embodiment. At step 501, the AI-assisted user training system 100 tokenizes the training data 102 with a language learning model into one or more vectors, the one or more vectors including a proficiency vector 142; a dependency vector 138; a complexity vector 140; and/or a compliance vector 146. Step 501 is similar to Step 202 of method 200 of FIG. 2, but further illustrates that AI-assisted user training system 100 may further generate complexity vectors 140 and compliance vectors 146.

At step 502, the AI-assisted user training system 100 inputs the request into a predictive resource engine 122 to determine a task complexity, the predictive resource engine 122 comprising the complexity vectors 140 and complexity logic. The complexity vectors of the predictive resource engine 122 may be trained to determine the complexity of a given task associated with the request. The complexity of the given task may relate to time estimates to complete the task, size estimate identifying the required data storage to implement the task, or other complications related to a given task identified in a request.

At step 503, the AI-assisted user training system 100 inputs the proficiency score into the predictive resource engine 122. Thus, according to some examples, the predictive resource engine 122 accounts for the proficiency of a user 136, as determined by the adaptive response engine 124, in determining a task complexity. For example, if the user inputting the request has a lower proficiency score, the predictive resource engine 122 may increase the task complexity or increase the estimated projection of the resource expenditure required to complete the request. Higher proficiency scores may cause the predictive resource engine 122 to lower the task complexity or decrease the projected resource expenditure required to complete the request. At step 504, the AI-assisted user training system 100 projects, based on the task complexity, a resource expenditure required to complete the request.

At step 505, the AI-assisted user training system 100 outputs, as part of the response, the resource expenditure, for instance, through the chatbot 150 and interface 132.

Steps 506 and 507 are shown to independently stem from step 501 according to the embodiment of FIG. 2. At step 506, the AI-assisted user training system 100 inputs the request into a compliance engine 128 to determine a projected due date, the compliance engine 128 comprising the compliance vector 146 and compliance logic. As discussed with respect to the embodiment of FIG. 1, the compliance engine 128 may be enabled, e.g., through the compliance vectors 146 to determine the projected due date of a project based on training data 102 including regulatory documents, code document notes, and the like. At step 407, the AI-assisted user training system 100 outputs as part of the response, the projected due date for the request

FIG. 6 illustrates a method for outputting responses based on a compliance engine according to one embodiment. At step 601, the AI-assisted user training system 100 tokenize the training data 102 with a language learning model into one or more vectors, the one or more vectors including a proficiency vector 142; a dependency vector 138; a complexity vector 140; and/or a compliance vector 146.

At step 602, the AI-assisted user training system performs steps similar to step 502, wherein the AI-assisted user training system 100 inputs a received request into a predictive resource engine 122 to determine a task complexity, the predictive resource engine 122 comprising the complexity vectors 140 and complexity logic.

At step 603, the AI-assisted user training system 100 inputs the request into a compliance engine 128 to determine a projected due date, the compliance engine 128 comprising the compliance vector 146 and compliance logic. The compliance vectors 146 may comprise vectors trained by the training module 112 based on a subset of the training data 102, e.g., regulatory and compliance documents, to project an estimated due date of a request.

At step 604, the AI-assisted user training system 100 determines whether the projected time for completion (as determined at step 502) exceeds the projected due date (as determined at step 503). In response to determining the projected time for completion exceeds the projected due date, the AI-assisted user training system 100 proceeds to step 505. Otherwise, in response to determining the projected time for completion does not exceed the projected due date, the AI-assisted user training system 100 may return to step 502, where the AI-assisted user training system waits for another request to be received and analyzer per steps 502 and 503.

At step 605, the AI-assisted user training system 100 outputs an alert indicating that insufficient resources are allocated to complete the request prior to the projected due date.

### Example Method for Outputting Responses Based on Compliance Logic

FIG. 7 illustrates a method for outputting alerts based on resource expenditures and due dates according to one embodiment. At step 701, the AI-assisted user training system 100 tokenizes the training data 102 with a language learning model into one or more vectors, the one or more vectors including a proficiency vector 142; a dependency vector 138; a complexity vector 140; and/or a compliance vector 146. Step 601 is similar to steps 202, 401, and 501 of methods 200, 400, and 500 but further illustrates that AI-assisted user training system 100 may further generate sensitivity vectors 144.

At step 702, the AI-assisted user training system 100 identifies a software compliance requirement from software compliance logic, the software compliance logic comprising the compliance vector 146 and compliance logic. The sensitivity vectors 144 may be generated by the training module 112 using machine learning techniques, wherein the training module 112 trains a machine learning model to identify compliance requirements from gathered training data 102 such as regulatory documents, notes within application code, complaint reports, and the like.

At step 703, the AI-assisted user training system 100 outputs, as part of the response, the software compliance requirement. A user 136 submitting a request to through the interface 132 and chatbot 150 may for instance, request for the chatbot 150 to indicate the requirements related to developing a proposed software application. In response, the chatbot 150 can output the one or more software compliance requirements associated with proposed software application. The chatbot 150, through the compliance engine 128, can for instance retrieve and provide to the user a summary of all the relevant regulatory documents, or links to the relevant regulatory documents.

### Example Method for Masking Sensitive Data

FIG. 8 illustrates a method of masking sensitive data within the training data 102 according to one embodiment. At step 801, the AI-assisted user training system 100 tokenizes the training data 102 with a language learning model into one or more vectors, the one or more vectors including a proficiency vector 142 and/or a sensitivity vector 144.

At step 802, the AI-assisted user training system 100 identifies, by the sensitive data masker 126, sensitive data within the training data 102, the sensitive data masker 126 comprising the sensitivity vector 144 and sensitivity logic. In other examples the sensitive data masker 126 may only comprise sensitivity logic in the form of natural language processing algorithms, and not include sensitivity vectors 144 generated through machine learning models. In such cases, the sensitive data masker 126 may mask sensitive data within the training data 102, prior to the training module 112 performing any machine learning to generate the vectors 138-146 within the vector store. In other examples, the sensitive data masker 126 may be augmented by sensitivity vectors 144 trained by the training module 112 to further predict and identify sensitive data within the training data 102 when the training module 112 retrains on the training data 102 per the automated retraining system 116. At step 703, the AI-assisted user training system 100 automatically masks the sensitive data within the training data 102.

### Example Computing System for Implementing the AI-Assisted User Training System

Any suitable computing system or group of computing systems can be used for performing the operations described herein. For example, FIG. 9 illustrates a block diagram for an example computing environment capable of executing the described systems and methods, according to certain embodiments.

The depicted example of a computing system 902 includes one or more processors 906 communicatively coupled to one or more memory devices 904. The processor 906 executes computer-executable program code or accesses information stored in the memory device 904. Examples of processor 906 include a microprocessor, an application-specific integrated circuit (“ASIC”), a field-programmable gate array (“FPGA”), or other suitable processing device. The processor 906 can include any number of processing devices, including one.

The memory device 904 includes any suitable non-transitory computer readable medium for storing the machine learning models 922, automated retraining system 924, vector store 926 and other received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 902 may also include a number of external or internal devices such as input or output devices. For example, the computing system 902 is shown with an input/output (“I/O”) interface 908 that can receive input from input devices or provide output to output devices. A bus 908 can also be included in the computing system 902. The bus 908 can communicatively couple one or more components of the computing system 902.

The computing system 902 executes program code that configures the processor 906 to perform one or more of the operations described above with respect to FIGS. 1-8. The program code includes operations related to, for example, receiving requests and training data 102, generating vectors for operation with the extraction module 118, and processing the requests based on the vectors and extraction module 118, or other suitable applications or memory structures that perform one or more operations described herein. The program code may be resident in the memory device 904 or any suitable non-transitory computer-readable medium and may be executed by the processor 906 or any other suitable processor. In some embodiments, the program code described above, the machine learning models 922, automated retraining system 924, vector store 926 and other received or determined values or data objects are stored in the memory device 904, as depicted in FIG. 9. In additional or alternative embodiments, one or more of the machine learning models 922, automated retraining system 924, vector store 926, and other received or determined values or data objects and the program code described above are stored in one or more memory devices accessible via a data network, such as a memory device accessible via a cloud service.

The computing system 902 depicted in FIG. 9 also includes at least one network interface 912. The network interface 912 includes any device or group of devices suitable for establishing a wired or wireless data connection to one or more data networks 914 such as viewing applications 920 including user interfaces. Non-limiting examples of the network interface 912 include an Ethernet network adapter, a modem, and/or the like. A remote communication service 918 is connected to the computing system 902 via network 914 and can perform some of the operations described herein including receiving requests and training data, generating vectors for operation with the extraction module 118, and processing the requests based on the vectors and extraction module 118 logic. The computing system 902 is able to communicate with one or more of the remote communication service 918 and the machine learning models 922 using the network interface 910. Although FIG. 9 depicts the machine learning models 922 as connected to computing system 902 via the network 914, other embodiments are possible, including the machine learning models 922 running as a program in the memory device 904 of computing system 902.

### Advantages of Systems and Methods for an AI-Assisted User Training System

The AI-assisted user training system, through the disclosed machine learning models, vectors, and extraction components, is able to efficiently gather and summarize data provided to users through a chatbot interface. The chatbot interface provides an improved means for users such as web-developers in the field of software development, particularly in the context of team-based software development. Compared to prior computer training software, the AI-assisted user training system 100 provides a uniform interface responsive to user requests and is further capable of predicting needs of the user even when unanticipated by the user.

The AI-assisted user training system also provides solutions necessarily rooted in computer technology to overcome problems specifically arising in computer training software. For example, previous training software could not intuitively adapt to the level of experience and sophistication associated with a user. Prior interfaces and displays may provide inaccurate information, or imprecise information that is vague and/or overbroad, requiring the user to have to filter through the software interface to eventually reach the requested information. The disclosed system, applying an intuitive, natural language processing and machine learning based system to intuitively adapt to the relative sophistication and expertise of the user in providing a tailored-response resolves inefficiencies of previous user-training interfaces.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein. Other examples may include more operations, fewer operations, different operations, or a different order of the operations shown in FIGS. 2-8.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes,” “having,” “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

What is claimed is:

1. A method comprising:
receiving training data;
tokenizing the training data with a language learning model into one or more vectors including a proficiency vector, and storing the one or more vectors;
receiving a request from a user;
generating a proficiency score by inputting the request into an adaptive response engine comprising the proficiency vector and proficiency logic;
assigning the proficiency score to the user;
generating a response associated with the request based on the proficiency score and programmed query response logic; and
outputting the response.

2. The method of claim 1 wherein generating the response associated with the request further comprises:
receiving a baseline response from the programmed query response logic;
determining a selected sophistication range associated with the proficiency score;
modifying the baseline response based on the selected sophistication range; and
outputting the modified baseline response as the response.

3. The method of claim 1, wherein the one or more vectors includes a dependency vector, the request comprises a request to modify a first software, and the method further comprises:
identifying an effect of the request on a second software by inputting the request into a dependency impact engine, the dependency impact engine comprising the dependency vector and dependency logic; and
outputting, as part of the response, an indication that a modification to the first software affects the second software.

4. The method of claim 1, wherein the one or more vectors includes a complexity vector, the method further comprising:
inputting the request into a predictive resource engine to determine a task complexity, the predictive resource engine comprising the complexity vector and complexity logic;
projecting, based on the task complexity, a resource expenditure required to complete the request; and
outputting, as part of the response, the resource expenditure.

5. The method of claim 4, wherein the resource expenditure includes a size estimation of a task identified within the request.

6. The method of claim 5, wherein the one or more vectors includes a compliance vector, the method further comprising:
receiving a projected due date from a compliance engine, the compliance engine comprising the compliance vector and compliance logic; and
outputting, as part of the response, the projected due date for the request.

7. The method of claim 6, wherein the resource expenditure includes a projected time for completion of the request; and wherein the method further comprises:
determining the projected time for completion of the request exceeds the projected due date for the request; and
outputting an alert indicating that insufficient resources are allocated to complete the request prior to the projected due date.

8. The method of claim 5, wherein the inputting the request into the predictive resource engine to determine a task complexity further includes inputting the proficiency score into the predictive resource engine.

9. The method of claim 1, wherein the one or more vectors includes a compliance vector, the method further comprising:
identifying a software compliance requirement from a compliance engine, the compliance engine comprising the compliance vector and compliance logic; and
outputting, as part of the response, the software compliance requirement.

10. The method of claim 1, wherein the one or more vectors includes a sensitivity vector, the method further comprising:
identifying, by a sensitive data masker, sensitive data within the training data, the sensitive data masker comprising the sensitivity vector and sensitivity logic; and
automatically masking the sensitive data within the training data.

11. A system comprising:
one or more processors configured to:
receive training data;
tokenize the training data with a language learning model into one or more vectors, including a proficiency vector, and storing the one or more vectors;
receive a request from a user;
generate a proficiency score by inputting the request into an adaptive response engine comprising the proficiency vector and proficiency logic;
assign the proficiency score to the user;
generate a response associated with the request based on the proficiency score and programmed query response logic; and
output the response.

12. The system of claim 11, wherein causing the one or more processors to generate the response associated with the request based on the proficiency score and the programmed query response logic comprises causing the one or more processors to:
receive a baseline response from the programmed query response logic;
determine a selected sophistication range associated with the proficiency score;
modify the baseline response based on the selected sophistication range; and
output the modified baseline response as the response.

13. The system of claim 11, wherein the one or more vectors includes a dependency vector, the request comprises a request to modify a first software, and wherein the one or more processors are further configured to:
identify an effect of the request on a second software by inputting the request into a dependency impact engine, the dependency impact engine comprising the dependency vector and dependency logic; and
output, as part of the response, an indication that a modification to the first software affects the second software.

14. The system of claim 11, wherein the one or more vectors includes a complexity vector, and wherein the one or more processors are configured to:
input the request into a predictive resource engine to determine a task complexity, the predictive resource engine comprising the complexity vector and complexity logic;
project, based on the task complexity, a resource expenditure required to complete the request; and
output, as part of the response, the resource expenditure.

15. The system of claim 14, wherein the resource expenditure includes a size estimation of a task identified within the request.

16. The system of claim 14, wherein the one or more vectors includes a compliance vector, wherein the one or more processors are further configured to:
receive a projected due date from a compliance engine, the compliance engine comprising the compliance vector and compliance logic; and
output, as part of the response, the projected due date for the request.

17. The system of claim 16, wherein the resource expenditure includes a projected time for completion of the request, and wherein the one or more processors are further configured to:
determine the projected time for completion of the request exceeds the projected due date for the request; and
output an alert that insufficient resources are allocated to complete the request prior to the projected due date.

18. The system of claim 15, wherein the one or more processors are further configured to:
input the request into the predictive resource engine to determine a task complexity by inputting the proficiency score into the predictive resource engine.

19. The system of claim 11, wherein the one or more vectors includes a compliance vector, and wherein the one or more processors are further configured to:
identify a software compliance requirement from a compliance engine, the compliance engine comprising the compliance vector and compliance logic; and
output, as part of the response, the software compliance requirement.

20. A non-transitory computer readable medium comprising instructions that, when executed by one or more processors, cause the one or more processors to:
receive training data;
tokenize the training data with a language learning model into one or more vectors, including a proficiency vector, and storing the one or more vectors;
receive a request from a user;
generate a proficiency score by inputting the request into an adaptive response engine comprising the proficiency vector and proficiency logic;
assign the proficiency score to the user;
generate a response associated with the request based on the proficiency score and a programmed query response logic; and
output the response.
